(19) United States
(12) Patent Application Publication
(10) Pub. No.: US 2006/0216135 A1
(43) Pub. Date: Sep. 28, 2006

(54) Decorative eyelet

(76) Inventor: Suzanne Marchesano, O'Fallon, IL (US)

Correspondence Address: Thomas S. Baker, Jr., 1371 West 3rd Avenue, Columbus, OH, 43212, US

(21) Appl. No.: 11/091,193

(22) Filed: Mar. 28, 2005

(51) Int. Cl. F16B 19/08

(52) U.S. Cl. 411/501

(57) ABSTRACT

A decorative eyelet has a head member and a hollow, thin-walled substantially cylindrical shank, a plurality of tab-defining slits formed therein, which tabs are adapted to be bent radially outwardly from the shank to a position adjacent to and substantially parallel to the bottom surface of the head.

### BACKGROUND OF THE INVENTION

Decorative eyelets have many uses and may be used with many types of materials. For example, decorative eyelets may be affixed to the paper pages of scrapbooks and photograph albums. Also, they may be affixed to items of clothing and clothing accessories manufactured from a wide variety of clothing materials. Thin metallic pieces of artistic creation also may be applied to decorative eyelets. A typical eyelet has a head and a cylindrical shank, which extends laterally downwardly from the bottom surface of the eyelet head. In order to affix an eyelet to a piece of paper or other material, an opening is preformed in the material at the desired location. Thereafter, the eyelet shank is inserted in the opening. In a conventional eyelet, the cylindrical shank is a solid member and the eyelet is set by the insertion of a tool in the open end of the shank remote from the head. Thereafter, the tool is struck with a hammer to cause the lower portion of the shank to be deformed and the material to which the eyelet is applied to be squeezed between the bottom surface of the head and the deformed lower shank portion.

The process of striking a tool with a hammer to set a decorative eyelet frequently wrinkles or otherwise damages the material to which the eyelet is applied. This process is noisy and frequently chips the paint on a decorative eyelet. Furthermore, a table or piece of furniture used to support an eyelet may be damaged during the setting process. Additionally, it may be difficult to properly support an eyelet during the setting process. Also, it may be difficult to access the remote end of the eyelet shank such that a tool may be applied to carry out the setting process. Because of the potential damage to the material to which a decorative eyelet is applied and to the paint on an eyelet and because of the practical limitations in terms of eyelet support and access, the use of decorative eyelets for some applications has been limited.

It is desirable to provide a decorative eyelet which may be used with paper or other materials, which may be affixed to the paper or material without danger of damaging or wrinkling the materials, which does not require the eyelet to be supported during the setting process or set by a tool impacted by a hammer, and which may be set with a minimum of noise and without damage to the paint on an eyelet.

### SUMMARY OF THE INVENTION

A decorative eyelet has a head member with a decorative top surface, a bottom surface and a hollow, thin-walled, substantially cylindrical shank with a base adjacent the bottom surface which extends downwardly from the bottom surface. A plurality of longitudinally extending slits extending upwardly from the bottom end of the shank remote from the head define a plurality of tabs therebetween. The tabs are adapted to be bent radially outwardly about the shank base to a position adjacent to and substantially parallel to the bottom surface of the head without the use of a setting tool.

### BRIEF DESCRIPTION OF THE DRAWINGS

FIG. 1 illustrates a plurality of decorative eyelets of the instant invention affixed to the pages of a scrapbook;

FIG. 2 is a cross sectional view along line 2-2 of FIG. 1 depicting a set eyelet;

FIG. 3 is a perspective view of the bottom surface of a decorative eyelet of the instant invention which has not been set;

FIG. 4 is a perspective view of the bottom shank portion of a decorative eyelet of the instant invention which has been inserted through an opening formed in a piece of material, illustrating the method of setting the eyelet and showing the eyelet partially set;

FIG. 5 is a perspective bottom view of a prior art eyelet which has been inserted through an opening in a piece of material prior to setting the eyelet and depicting a prior art setting tool and a hammer; and

FIG. 6 is a plan view of the eyelet of FIG. 4 subsequent to the eyelet being completely set.

### DETAILED DESCRIPTION

Referring to FIG. 1, a plurality of decorative eyelets 10 of the instant invention are shown affixed to pages of a scrapbook B. The decorative eyelets 10 are mounted on pages of scrapbook B for ornamental and decorative purposes. In the embodiment depicted in FIG. 1, the decorative eyelet 10 has a generally planar head 12 with a top surface 14 shaped like a leaf. Top surface 14 may have any desired shape and may be painted a desired color. FIG. 3 shows the bottom surface 16 of eyelet head 12. A hollow, thin-walled substantially cylindrical shank 18 projects laterally downwardly from bottom surface 16. In the embodiment depicted in FIGS. 1 through 3, head 12 and shank 18 are formed from a single piece of metal. However, decorative eyelet 10 may be constructed where head 12 and shank 18 are formed from different pieces of metal and are attached by soldering, chemical bonding or other means. Applicant's invention is independent of whether decorative eyelet 10 is formed from a single piece of material or multiple pieces of material.

Turning again to FIG. 3, it may be seen that a plurality of generally parallel, longitudinally extending slits 20 are formed in the cylindrical side wall 22 of shank 18 parallel to the longitudinal axis thereof. The slits 20 extend upwardly from the bottom opening at the outer end 24 of shank 18 to the base 19 of shank 18 adjacent the bottom surface 16 of head 12 to define a plurality of bendable tabs 26.

In order to affix decorative eyelet 10 to a piece of material the eyelet 10 must be set.

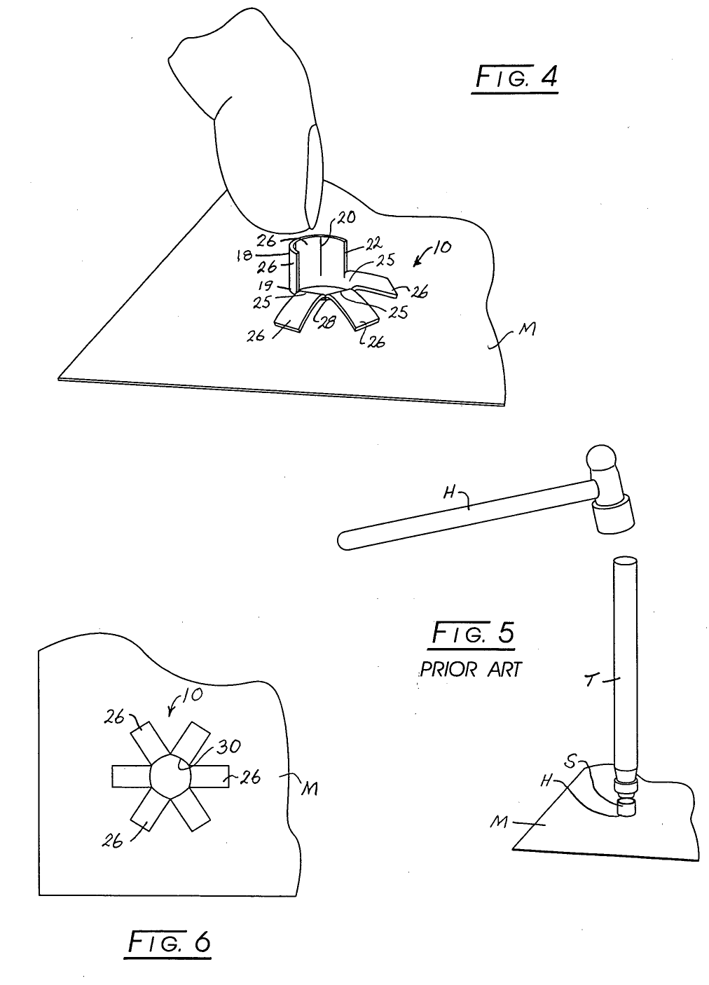

FIG. 5 illustrates a conventional eyelet shank S which has been inserted through a hole H formed in material M. The prior art shank S has a solid continuous (no slits formed therein) cylindrical side wall and is set by a tool T having an outer end adapted to engage the outer end of shank S. When force is applied to the end of tool T by hammer H, the tool acts on shank 18 and simultaneously collapses or crushes the side wall of shank 18 radially outwardly and downwardly toward the head such that the material M is clamped between the deformed side wall of shank S and the unseen head on the opposite side of the material M. Use of a hammer H and a tool T to set an eyelet is inconvenient at best in that it requires a secure support for the head portion of the eyelet during the time the tool is struck by the hammer. Additionally, it is difficult to regulate the force applied by the hammer to the tool, and the type and degree of deformation of the shank S of the eyelet is somewhat unpredictable. In some cases, the deformation may be insufficient to securely clamp the material M, and in other instances, the deformation may be to such a degree that the material is wrinkled in the area between the deformed shank and the eyelet head. Additionally, there are many instances when it is inconvenient to access the outer end of an eyelet shank S to enable the tool to deform the shank.

Applicant's invention provides a decorative eyelet in which the shank may be deformed to thereby set the eyelet without the use of tools and in which the degree of deformation may be controlled easily.

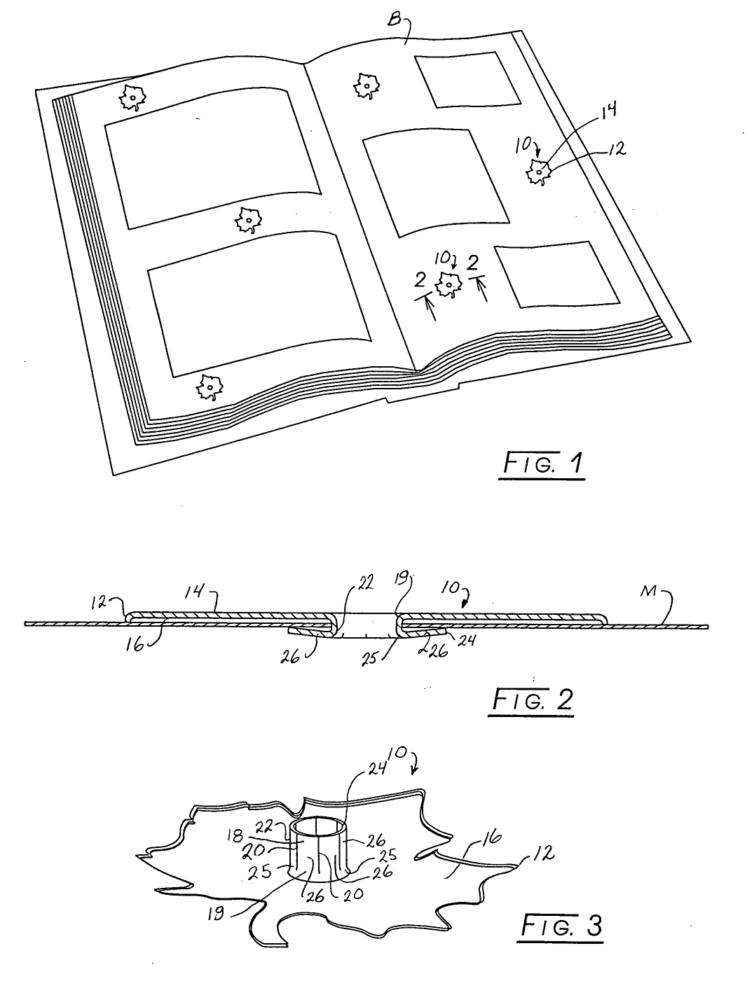

In the setting process, the shank 18 of eyelet 10 is inserted through a preformed or pre-existing hole or opening 28 in a piece of material M and thereafter the tabs 26 are bent radially outwardly about shank base 19 toward the bottom surface 16 of head 12 in such a manner as to trap the material M between the head bottom surface 16 and the deformed or bent tabs 26 of shank 18. See FIG. 2. FIG. 4 illustrates the shank 18 of a decorative eyelet 10 which has been inserted in an opening 28 which has been formed in material M. Three of the tabs 26 defined by slits 20 in the cylindrical side wall 22 of shank 18 have been bent radially outwardly to a position in which they are generally parallel to head 12 by pivoting about their inner ends 25 at shank base 19 adjacent to the bottom surface 16 of head 12 by application of a lateral force applied at the outer end of tabs 26 by a user's fingernail. See FIG. 4. The fully set eyelet 10 may be seen by referring to FIGS. 2 and 6.

In FIG. 6, it may be seen that tabs 26 may be bent over to extend radially outwardly of a central bore 30 formed in eyelet 10 to a position substantially parallel to that of head 12. Use of a finger or fingernail to deform or bend tabs 26 enables a user to precisely deform the tabs 26 to ensure the material M is clamped sufficiently but without wrinkling or other damage to the clamped material M. It should be noted that although head 12 is illustrated as having a central bore 30, only shank 18 requires a central bore. Head 12 may be a solid member with no bore.

The eyelet 10 of applicant's invention may be formed of any material which may be deformed readily and which will retain a set position. Such materials include steel, copper, aluminum, brass and other alloys or even non-metallic materials. Applicant prefers aluminum material because it is relatively inexpensive, easy to paint and resists rust and corrosion.

The thickness of the material from which the eyelet 10 is formed must be sufficient to allow the eyelet to retain a set position to properly clamp a material but thin enough to enable the tabs to be bent easily by the use of a fingernail. In the event a user does not wish to use a fingernail for fear of chipping nail polish, a simple pen or pencil may be utilized to bend the tabs 26. Applicant has found where an eyelet is formed from sheet aluminum the preferred thickness of the shank portion of the eyelet is in the range of 0.2 mm to 0.3 mm. A wall thickness of 0.25 mm is optimum.

The tabs 26 must be of sufficient length to properly clamp a piece of material. Applicant prefers a minimum tab length of 3.0 mm.

In the preferred embodiment of applicant's invention, the shank 18 of decorative eyelet 10 is illustrated as having six slits defining six tabs. Of course, applicant's invention will work where there are more or less slits defining more or less tabs. Three are a preferred minimal number of tabs. The number of tabs should be such as to enable a user to easily deform the tabs.

Eyelet 10 of the instant invention is illustrated as having an opening in the head 12 thereof. Of course, the central opening of shank 18 does not have to project through head 12 and head 12 may be solid.

Various changes may be made to the size, shape, and relative proportions of the different invention elements disclosed and described herein without departing from the scope, meaning, or intent of the claims which follow.

I claim as my invention:

1-8. (canceled)

9-16. (canceled)

17. A decorative eyelet comprising:
a head member 12 having a decorative top surface 14 and bottom surface 16;
a hollow, thin-walled substantially cylindrical shank 18 having a base 19 adjacent said bottom surface 16;
said shank 18 extending downwardly from and perpendicular to said bottom surface 16 and having a bottom opening at the outer end 24 thereof; and a plurality of longitudinally extending slits 20 which open into and extend upwardly from the bottom opening at the outer end 24 thereof of said shank 18 toward said head member bottom surface 16;
said slits extending perpendicular to said bottom surface 16;
said slits 20 defining a plurality of individual tabs 26 therebetween having unattached outer ends remote from said shank base 19 and extending from their outer ends to their bases perpendicular to said bottom surface 16 and adapted to be bent radially outwardly about said shank bases 19 to a position adjacent to and substantially parallel to said head bottom surface 16.

18. A decorative eyelet comprising:
a head member 12 having a decorative top surface 14 and bottom surface 16;
a hollow, thin-walled substantially cylindrical shank 18 having a base 19 adjacent said bottom surface 16;
said shank 18 extending downwardly from and perpendicular to said bottom surface 16 and having a bottom opening at the outer end 24 thereof; and
a plurality of longitudinally extending slits 20 which open into and extend upwardly from the bottom opening at the outer end 24 thereof of said shank 18 toward said head member bottom surface 16;
said slits extending perpendicular to said bottom surface 16;
said slits 20 defining at least three individual tabs 26 therebetween having unattached outer ends remote from said shank base 19 extending from their outer ends to their bases perpendicular to said bottom surface 16 and adapted to be bent radially about said shank bases 19 to a position adjacent to and substantially parallel to said head bottom surface 16.

19. The decorative eyelet of claim 18 wherein said slits 20 define six tabs 26.

20. A decorative eyelet comprising:
a head member 12 having a decorative top surface 14 and bottom surface 16;
a hollow, thin-walled substantially cylindrical shank 18 having a base 19 adjacent said bottom surface 16;
said shank 18 extending downwardly from and perpendicular to said bottom surface 16 and having a bottom opening at the outer end 24 thereof; and
a plurality of longitudinally extending slits 20 which open into and extend upwardly from the bottom opening at the outer end 24 thereof of said shank 18 toward said head member bottom surface 16;
said slits extending perpendicular to said bottom surface 16;
said slits 20 defining a plurality of individual tabs 26 therebetween having unattached outer ends remote from said shank base 19 extending from their outer ends to their bases 19 perpendicular to said bottom surface 16 and adapted to be bent radially about their shank bases 19 to a position adjacent to and substantially parallel to said head bottom surface 16;
and wherein said eyelet is formed from a malleable material.

21. The decorative eyelet of claim 20 wherein said eyelet is formed from aluminum.

22. The decorative eyelet of claim 21 wherein said eyelet is formed from steel.

23. The decorative eyelet of claim 20 wherein said eyelet has a thickness ranging between 0.010 inches and 0.030 inches (0.2 mm and 0.3 mm).

24. The decorative eyelet of claim 20 wherein said slits 20 define at least three tabs 26.
